(19) United States
(12) Patent Application Publication
(10) Pub. No.: US 2003/0062837 A1
(43) Pub. Date: Apr. 3, 2003

(54) Capillary discharge plasma display panel having field shaping layer and method of fabricating the same

(75) Inventors: Bhum Jae Shin, Rutherford, NJ (US); Dong Woo Yu, Demarest, NJ (US); Steven Kim, Harrington Park, NJ (US); Michael D. Martin, West New York, NJ (US); William Kokonaski, Gig Harbor, WA (US)

Correspondence Address: MORGAN LEWIS & BOCKIUS LLP, 1111 PENNSYLVANIA AVENUE NW, WASHINGTON, DC, 20004, US

(73) Assignee: Plasmion Display, LLC

(21) Appl. No.: 09/967,190

(22) Filed: Oct. 1, 2001

(51) Int. Cl. H01J 17/49

(52) U.S. Cl. 313/585

(57) ABSTRACT

The present invention discloses a capillary discharge plasma display panel having a field shaping layer and a method of fabricating the same. More specifically, a capillary discharge panel for generating a capillary plasma discharge includes first and second substrates forming at least one discharge space there between, the first and second substrates facing into each other, a first electrode on the first substrate, a first dielectric layer on the first electrode including the first substrate, at least one second electrode on the second substrate, a second dielectric layer on the second electrode and having at least one capillary per each discharge space therein, and a field shaping layer on the second dielectric layer to confine a generated field into the capillary and eliminate a glow discharge, wherein the discharge space directly faces into the capillary and each capillary corresponds to each discharge space.

### BACKGROUND OF THE INVENTION

1. Field of the Invention

The present invention relates to a plasma discharge panel, and more particularly, to a capillary discharge plasma display panel having a field shaping layer and method of fabricating the same. Although the present invention is suitable for a wide scope of applications, it is particularly suitable for optimizing a capillary discharge condition, thereby improving brightness as well as discharge efficiency of the capillary discharge plasma display panel.

2. Discussion of the Related Art

A plasma discharge panel (PDP) has been considered the most suitable flat panel display device for a large size, exceeding over 20 inches because it can be realized as a thin and large size flat panel device. It is also considered to be applicable to a high definition TV (HDTV). Accordingly, in order to improve a stable full color display PDP, extensive research and development has been performed in the display industry.

Both AC and DC-operated plasma display panel structures have been employed in operating the PDP. A DC-operated PDP employs DC electrodes that are in direct contact with the gas, but has to employ a current limiting device such as a resistor in the drive circuit to prevent excessive current flow when the gas discharges. In order to confine the discharge area within a PDP, dielectric barriers are located between the pixel cells and prevent the spread of the ionized gas.

As well known, a dielectric layer is the most commonly used insulating layer that prevents destructive arc discharge in the panel. A partial cross-sectional view of a conventional barrier type AC PDP is illustrated in FIG. 1.

Referring to FIG. 1, the conventional barrier type AC PDP as disclosed in U.S. Pat. No. 5,990,854 includes front and rear glass substrates 10 and 12 that enclose a discharge gas 14 filled in a discharge chamber. More specifically, row electrodes 16 are formed on the front glass substrate 10. The row electrodes 16 are completely covered with a first dielectric layer 20. Similarly, a column electrode 18 is formed on the rear glass substrate 12 and is completely buried by a second dielectric layer 22 in order to prevent arc discharge on the surface of the column electrode 18.

Generally, the conventional barrier type AC PDP generates low density plasma, resulting in low brightness and a slow response time due to a long discharging time on the dielectric wall.

### SUMMARY OF THE INVENTION

Accordingly, the present invention is directed to a capillary discharge plasma discharge panel having a field shaping layer and method of fabricating the same that substantially obviates one or more of problems due to limitations and disadvantages of the related art.

Another object of the invention is to provide a capillary discharge plasma panel and method of fabricating the same in that it optimizes a capillary discharge condition, thereby improving brightness of the capillary discharge plasma display panel.

Additional features and advantages of the invention will be set forth in the description, which follows and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a capillary discharge plasma display panel for generating a capillary discharge plasma includes first and second substrates forming at least one discharge space therebetween, the first and second substrates facing into each other, a first electrode on the first substrate, a first dielectric layer on the first electrode including the first substrate, at least one second electrode on the second substrate, a second dielectric layer on the second electrode and having at least one capillary per each discharge space therein, and a field shaping layer on the second dielectric layer to confine a generated field into the capillary and eliminate a glow discharge, wherein the discharge space directly faces into the capillary and each capillary corresponds to each discharge space.

In another aspect of the present invention, a capillary discharge plasma display panel for generating a capillary discharge plasma includes first and second substrates forming at least one discharge space therebetween, the first and second substrates facing into each other, a first electrode on the first substrate, a first dielectric layer on the first electrode including the first substrate, a pair of second and third electrodes on the second substrate, a second dielectric layer on the second and third electrodes and having at least one capillary per each discharge space therein, and a field shaping layer on the second dielectric layer to confine a generated field into the capillary and eliminate a glow discharge, wherein the discharge space directly faces into the capillary and at least one capillary corresponds to each discharge space.

In another aspect of the present invention, a method of fabricating a capillary discharge plasma display panel having a pair of first and second substrates facing into each other with a discharge space therebetween, the method comprising the steps of forming a first electrode on the first substrate, forming a first dielectric layer on the first electrode including the first substrate, forming at least one second electrode on the second substrate, forming a second dielectric layer on the second electrode, the second dielectric layer forming at least one capillary per each discharge space in the second dielectric layer, forming a field shaping layer on the second dielectric layer to confine a generated field into the capillary and eliminate a glow discharge, wherein the discharge space faces into the capillary and each capillary corresponds to each discharge space.

In a further aspect of the present invention, a method of fabricating a capillary discharge plasma display panel having a pair of first and second substrates facing into each other with a discharge space therebetween for generating a capillary discharge plasma, the method including the steps of forming a first electrode on the first substrate, forming a first dielectric layer on the first electrode including the first substrate, forming at least a pair of second and third electrodes on the second substrate, forming a second dielectric layer on the second and third electrodes and having at least one capillary therein, and forming a field shaping layer on the second dielectric layer to confine a generated field into the capillary and eliminate a glow discharge, wherein the discharge space directly faces into the capillary and at least one capillary corresponds to each discharge space.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention.

In the drawings:

FIG. 1 is a cross-sectional view of a prior art AC plasma display panel;

FIG. 2 is a cross-sectional view of a capillary discharge plasma display panel according to a first embodiment of the present invention;

FIGS. 3A and 3B are a cross-sectional view and a partial plan view of a capillary discharge plasma display panel according to a second embodiment of the present invention, respectively;

FIGS. 4A and 4B are a cross-sectional view and a partial plan view of a capillary discharge plasma display panel according to a third embodiment of the present invention, respectively;

FIG. 5 is a schematic diagram of laser optics used in forming a capillary in a dielectric layer of the capillary discharge plasma display panel according to the present invention; and

FIGS. 6A to 6J are cross-sectional views illustrating fabrication process steps for the capillary plasma display panel according to the present invention.

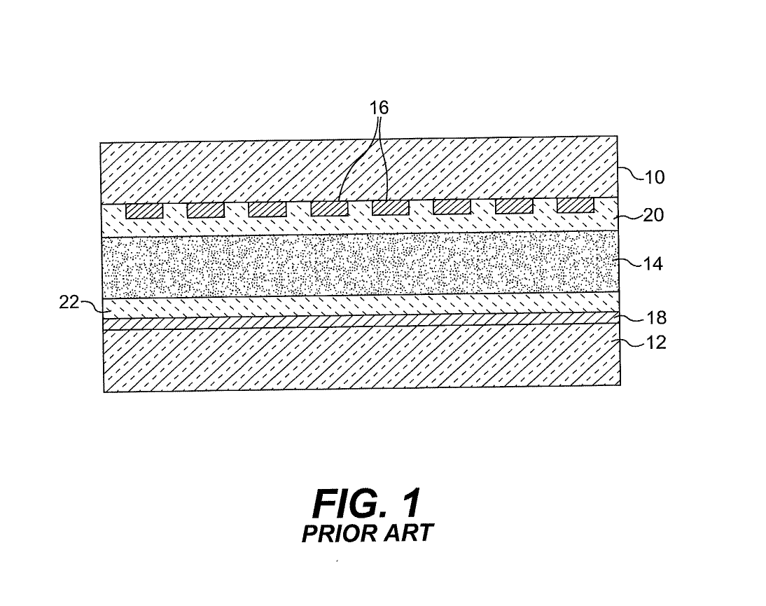

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

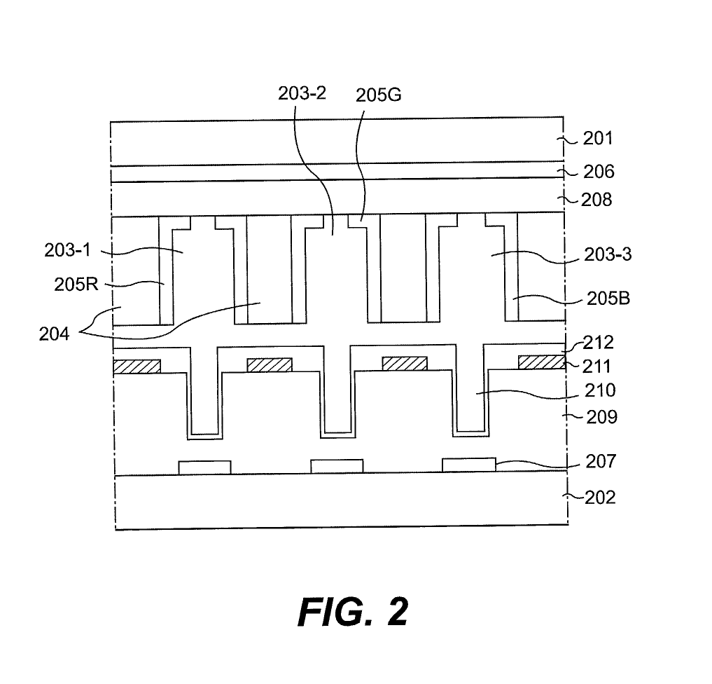

FIG. 2 is a cross-sectional view of a capillary discharge plasma display panel (PDP) according to a first embodiment of the present invention. As shown in FIG. 2, a capillary discharge plasma display panel of the first embodiment includes first and second substrates 201 and 202 forming discharge spaces 203-1, 203-2, and 203-3 therebetween and facing into each other. A pair of barrier ribs 204 define each discharge space. For realizing a full color representation, the three discharge spaces 203-1, 203-2, and 203-3 representing R, G, and B are required in the unit pixel. Phosphor conversion layers 205R, 205G, and 205B are deposited on the inner walls of each discharge space.

A first electrode 206 serving as an address electrode and a sustain electrode as well is formed on the first substrate 201. Similarly, a second electrode 207 serving as a bus electrode is formed on the second substrate 202. First and second dielectric layers 208 and 209 are formed on the first electrode 206 and the second electrode 209, respectively. Lead oxide (PbO), for example, may be the choice of material for the first and second dielectric layers 208 and 209.

At least one capillary 210 per each sub-pixel is formed in the second dielectric layer 209 for providing a site for capillary discharge. The number and the dimension of the capillaries may be varied with sizes of the unit cell and the second electrode 207. For example, the capillaries have a diameter in the range of 5 and 500 μm. The second electrode 207 may be exposed to the capillary 210. Alternatively, a gap between the second electrode 207 and the capillary 210 exists, so that the second electrode 207 is buried by the second dielectric layer 209. The gap may be varied up to about a half thickness of the second dielectric layer 209. The discharge spaces 203-1, 203-2, and 203-3 directly face into the capillaries and each capillary corresponds to each discharge space. A thickness of the dielectric layer in the second electrode 207 may be varied to obtain a glow discharge.

A field shaping layer 211 is deposited on the second dielectric layer 209 in order to confine a generated field into the capillary as well as to eliminate a glow discharge. For example, indium tin oxide (ITO) or transparent conducting oxide (TCO) may be used as the field shaping layer 211. A thickness of the field shaping layer 211 is in the range of 5 and 500 μm. A diameter of the field shaping layer is larger than that of the capillary diameter by 5 to 50 μm. In operation, the field shaping layer 211 can be floated or may be applied with about 30 to 50% of a driving voltage.

Further, a protective layer 212, such as magnesium oxide (MgO), may be formed on the field shaping layer 211 as well as on the PbO layer in the gap between the field shaping layer and inner walls of the capillary for protecting the electrode from erosion by an ion bombardment. A third dielectric layer (not shown in FIG. 2) may be deposited between the protective layer 212 and the field shaping layer 211 for further protection of the electrode. The protective layer 212 also decreases a breakdown voltage due to a relatively large value in secondary electron emission. A thickness of 1 to 20 μm may be appropriate for this purpose.

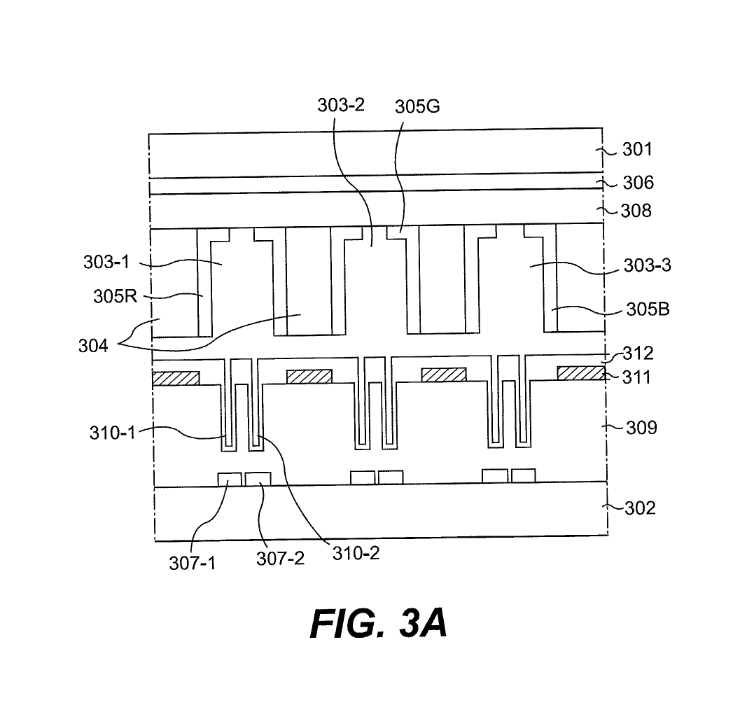

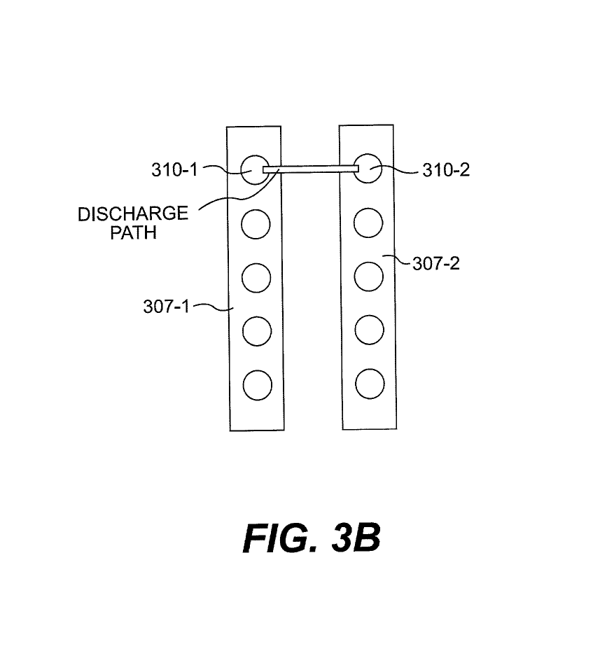

A second embodiment of the present invention is illustrated in FIGS. 3A and 3B. In the second embodiment, a pair of second and third electrodes 307-1 and 307-2 are formed on a second substrate 302 facing into a first substrate 301, as shown in FIG. 3A. A first electrode 306 for addressing is formed on the first substrate 301. First and second dielectric layers 308 and 309 are formed to bury the first electrode 306 and the second and third electrodes 307-1 and 307-2, respectively.

In the second dielectric layer 309, at least one a pair of first and second capillaries 307-1 and 307-2 per each discharge space is formed therein. As shown in FIGS. 3A and 3B, the first and second capillaries 307-1 and 307-2 are coupled to each other, so that each discharge path is formed between the adjacent first and second capillaries in the direction of about 90 degrees from the electrodes.

Similar to the first embodiment, the number and dimension of the capillaries may be varied with the sizes of the unit cell and the second and third electrodes 307-1 and 307-2. For example, the capillaries have a diameter in the range of 5 and 500. Since the other elements are similar to the first embodiment, detailed descriptions for those will not be repeated herein for simplicity.

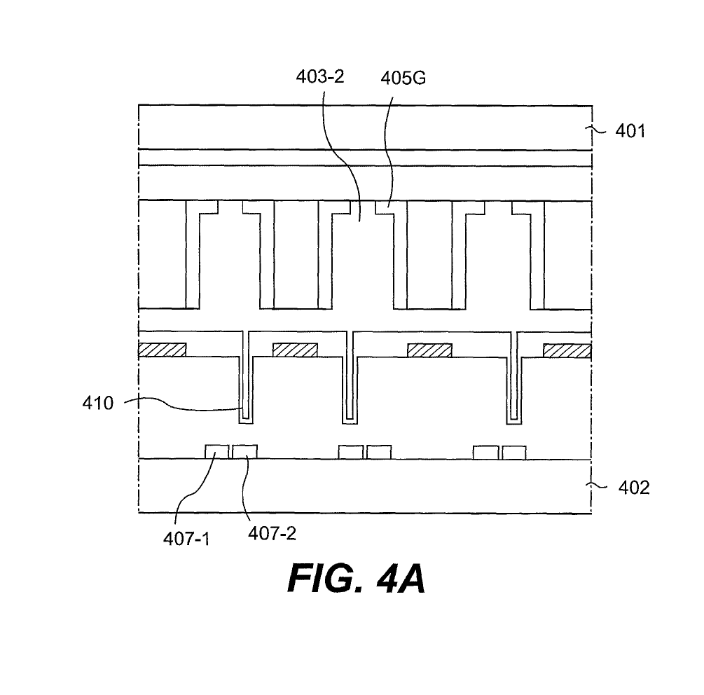

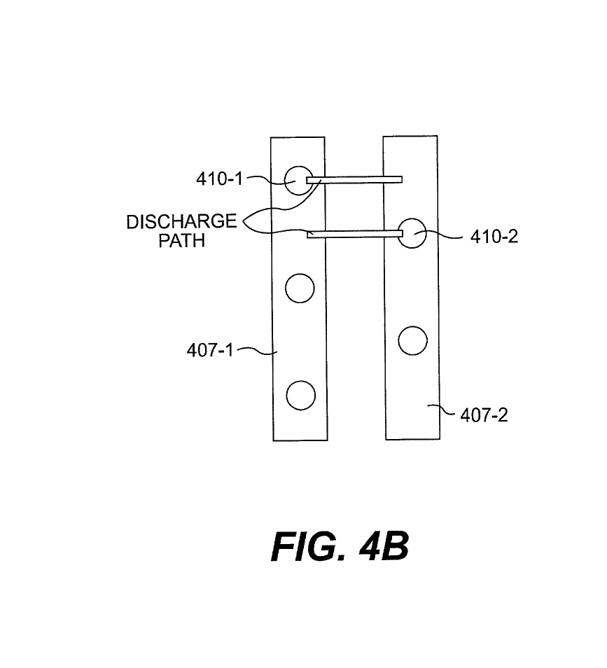

A third embodiment of the present invention is illustrated in FIGS. 4A and 4B. The third embodiment is similar to the second embodiment except for formation of the capillary. Thus, detailed descriptions other than the capillary formation are omitted for simplicity.

As shown in FIGS. 4A and 4B, only one capillary 410 per each discharge space is alternatively formed in the direction of about 90 degrees from the second and third electrodes 407-1 and 407-2. Thus, each discharge path is not formed between the adjacent capillaries over each second and third electrodes 407-1 and 407-2 in capillary discharge. The adjacent capillaries are formed to have an angle of about 45 degrees with respect to the direction along the second and third electrodes 407-1 and 407-2. Therefore, the adjacent capillaries formed over each second and third electrodes 407-1 and 407-2 are not coupled to each other to form a discharge path as shown in FIG. 4B. The number and dimension of the capillary may be varied with the sizes of the unit cell and the second and third electrodes 407-1 and 407-2.

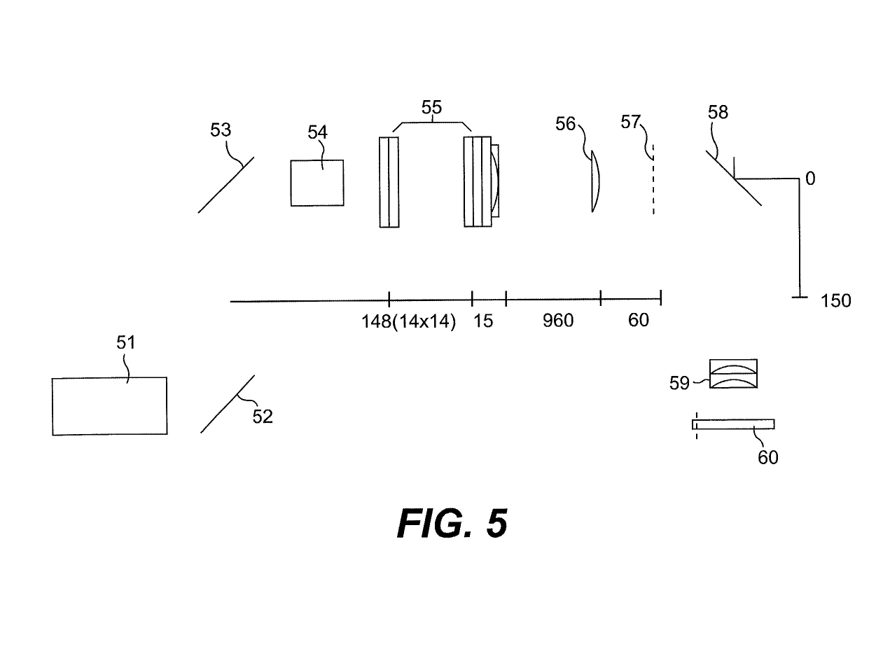

In FIG. 5, a schematic diagram of laser optics for forming a capillary is illustrated. Laser optics comprises a Krypton Fluoride (KrF) laser 51, first and second mirrors 52 and 53, an attenuator 54, a homogenizer 55, a field lens 56, a mask 57, a third mirror 58, and an objective 59. A substrate 60 is positioned below the objective 59. Process conditions are as follows: laser wavelength of 248 nm, 5× demagnification, energy density on substrate of 1.8 to 2.2 J/cm², and repetition rate of 20 Hz (pulse/sec).

A method of fabricating a capillary plasma display panel according to the present invention will now be explained with reference to the accompanying drawings.

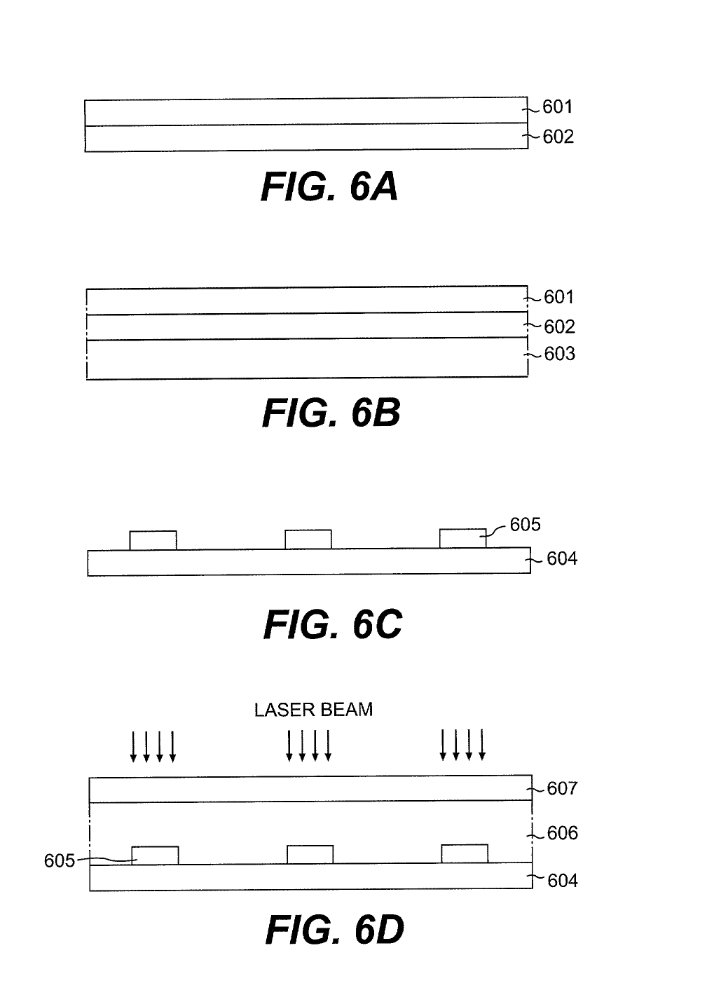

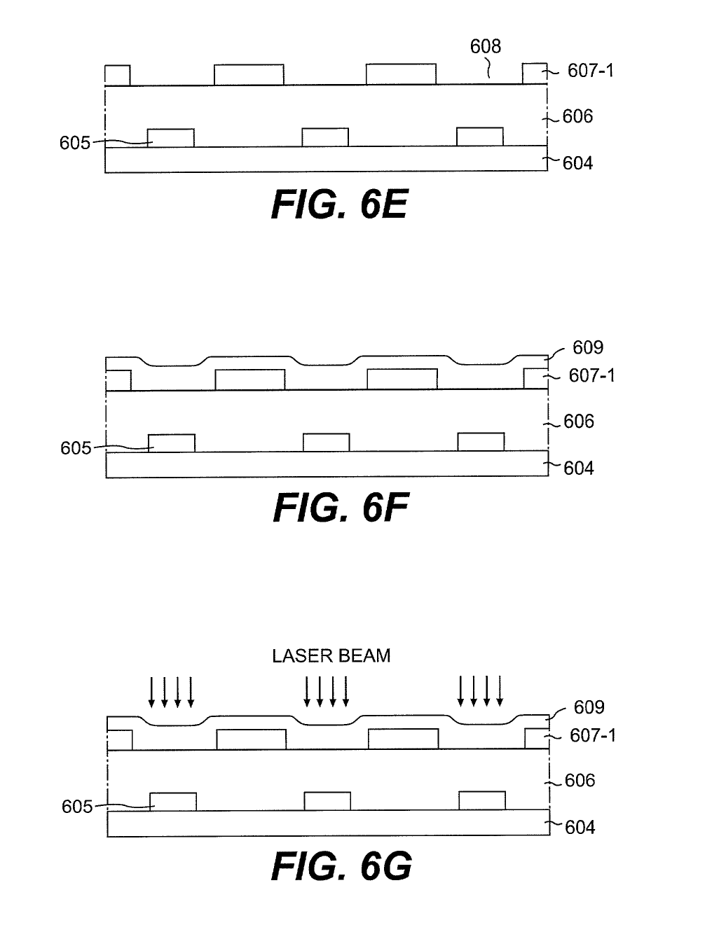

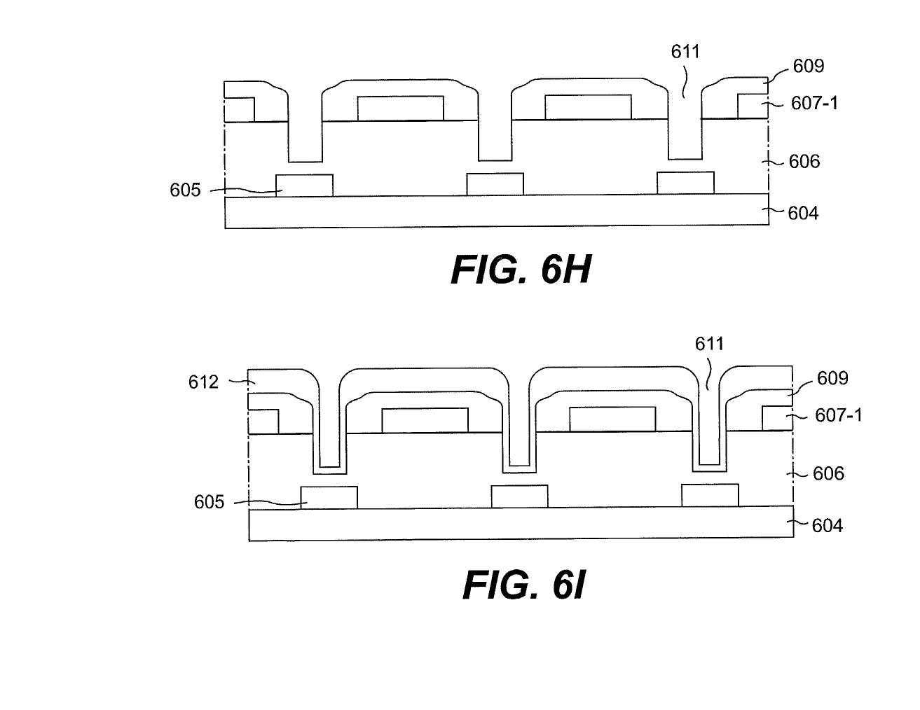

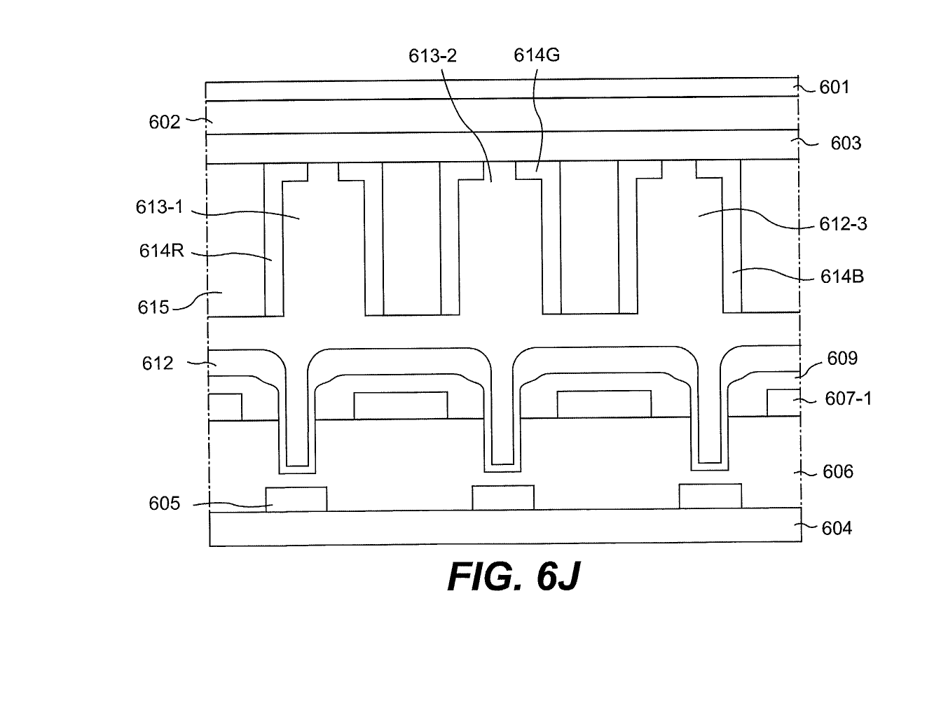

Initially referring to FIG. 6A, a first electrode 602 is formed on a first substrate 601. The first electrode may be formed 602 of ITO in order to pass light through the first substrate 601.

In FIG. 6B, a first dielectric layer 603 is deposited to cover the first electrode 602 and separates the first electrode 602 from discharge spaces (shown in FIG. 2 as reference numbers 203-1, 203-2, and 203-3).

On a second substrate 604, at least one second electrode 605 per discharge space is formed thereon and acts as a bus electrode in FIG. 6C. For example, the second electrode may be formed of silver (Ag).

Further, a second dielectric layer 606 and a field shaping layer are successively formed on the second substrate 604 including the second electrode 605, as shown in FIG. 6D. Thereafter, in order to form a capillary in the second dielectric layer in the embodiments of the present invention, the laser optics shown in FIG. 5 is used.

In FIG. 6E, a first portion 608 of a capillary is formed in the field shaping layer 607. In FIG. 6F, a third dielectric layer 609 such as PbO may be deposited on the surface of the second dielectric layer 606 including the first portion 608 of the capillary and the remaining portion 607-1 of the field shaping layer. In this process the third dielectric layer is formed to have a thickness in the range of about 1 and 20 μm. Thus, a break down of the electrode may be prevented. In addition, it prevents discharge from occurring at the surface of the capillary rather than in the capillary.

In FIG. 6G, a laser beam is applied to within the first portion 608 of the capillary of the overall surface to form a capillary in the second dielectric layer 606. In the above processes, the Krypton Fluoride (KrF) laser having a wavelength of 248 nm is employed using a laser fluence of about 1.8 to 2.2 J/cm² or higher and an ablation rate of about 0.111 μm/shot. A laser beam having a spot size of about 1.2 mm×1.2 mm is reduced by using a mask.

A capillary 611 is then formed in the second dielectric layer 606, as shown in FIG. 6H. Further, a protective layer such as magnesium oxide (MgO) is deposited on the overall surface of the third dielectric layer 612 including the field shaping layer 607.

After each discharge space defined by forming a pair of barrier ribs, phosphor conversion layers are formed inside walls of the discharge spaces. Thereafter, in FIG. 6I, a capillary discharge plasma display panel according to the present invention is completed by bonding the first and second substrates 601 and 604 by a seal frame layer (not shown).

As described above, the present invention provides the capillary discharge plasma display panel and method of fabricating the same in which improves brightness as well as discharge efficiency due to its structure for optimizing capillary discharge condition.

It will be apparent to those skilled in the art that various modifications and variations can be made in the capillary discharge plasma display panel having a field shaping layer and method of fabricating the same of the present invention without departing from the spirit or scope of the inventions. Thus, it is intended that the present invention covers the modifications and variations of this invention provided they come within the scope of the appended claims and their equivalents.

What is claimed is:

1. A capillary discharge plasma display panel for generating a capillary discharge plasma, comprising:
first and second substrates forming at least one discharge space therebetween, the first and second substrates facing into each other;
a first electrode on the first substrate;
a first dielectric layer on the first electrode including the first substrate;
at least one second electrode on the second substrate;
a second dielectric layer on the second electrode and having at least one capillary per each discharge space therein; and
a field shaping layer on the second dielectric layer to confine a generated field into the capillary and eliminate a glow discharge,
wherein the discharge space directly faces into the capillary and each capillary corresponds to each discharge space.

2. The plasma display panel according to claim 1, further comprising a protective layer on the field shaping layer.

3. The plasma display panel according to claim 2, wherein the protective layer is formed of MgO.

4. The plasma display panel according to claim 1, further comprising at least a pair of barrier ribs to define the discharge space.

5. The plasma display panel according to claim 1, further comprising a phosphor conversion layer on inner walls of the discharge space.

6. The plasma display panel according to claim 1, further comprising a third dielectric layer on the field shaping layer.

7. The plasma display panel according to claim 6, wherein the third dielectric layer has a thickness in the range of 1 and 20 μm.

8. The plasma display panel according to claim 1, wherein the field shaping layer includes one of indium tin oxide and transparent conducting oxide.

9. The plasma display panel according to claim 1, wherein the field shaping layer is floating or about 30 to 50% of a driving voltage is applied in diving the plasma display panel.

10. The plasma display panel according to claim 1, wherein the field shaping layer has a thickness in the range of 500 and 5000 Å.

11. The plasma display panel according to claim 1, wherein the capillary has a diameter in the range of 5 and 500 μm.

12. The plasma display panel according to claim 1, wherein the first electrode serves as an addressing electrode and a sustain electrode as well.

13. The plasma display panel according to claim 1, wherein a portion of the second electrode is exposed to each capillary.

14. The plasma display panel according to claim 1, wherein the second electrode and the capillary are separated by a distance up to a half thickness of the second dielectric layer.

15. A capillary discharge plasma display panel for generating a capillary plasma discharge, comprising:
first and second substrates forming at least one discharge space therebetween, the first and second substrates facing into each other;
a first electrode on the first substrate;
a first dielectric layer on the first electrode including the first substrate;
a pair of second and third electrodes on the second substrate;
a second dielectric layer on the second and third electrodes and having at least one capillary per each discharge space therein; and
a field shaping layer on the second dielectric layer to confine a generated field into the capillary and eliminate a glow discharge,
wherein the discharge space directly faces into the capillary and at least one capillary corresponds to each discharge space.

16. The plasma display panel according to claim 15, wherein the capillary includes first and second capillaries respectively corresponding to the second and third electrodes in each discharge space.

17. The plasma display panel according to claim 15, wherein the second and third electrodes are sequentially parallel to each other.

18. The plasma display panel according to claim 15, wherein each adjacent first and second capillaries are formed to have an angle of about 45 degrees with respect to each discharge path.

19. The plasma display panel according to claim 15, further comprising a protective layer on the field shaping layer.

20. The plasma display panel according to claim 19, wherein the protective layer is formed of MgO.

21. The plasma display panel according to claim 19, further comprising at least a pair of barrier ribs to define the discharge space.

22. The plasma display panel according to claim 19, further comprising a phosphor conversion layer on inner walls of the discharge space.

23. The plasma display panel according to claim 19, wherein the field shaping layer includes one of indium tin oxide and transparent conducting oxide.

24. The plasma display panel according to claim 19, wherein the field shaping layer is floating or about 30 to 50% of a driving voltage is applied in driving the plasma display panel.

25. The plasma display panel according to claim 19, wherein the field shaping layer has a thickness in the range of 500 and 5000 Å.

26. The plasma display panel according to claim 19, wherein the capillary has a diameter in the range of 5 and 500 μm.

27. The plasma display panel according to claim 19, wherein the first electrode serves as an addressing electrode and a sustain electrode as well.

28. The plasma display panel according to claim 19, further comprising a third dielectric layer on the field shaping layer.

29. The plasma display panel according to claim 28, wherein the third dielectric layer has a thickness in the range of 5 and 20 μm.

30. The plasma display panel according to claim 19, wherein a portion of the second electrode is exposed to each capillary.

31. The plasma display panel according to claim 19, wherein the second electrode and the capillary are separated by a distance up to a half thickness of the second dielectric layer.

32. A method of fabricating a capillary discharge plasma display panel having a pair of first and second substrates facing into each other with a discharge space there between, the method comprising the steps of:
forming a first electrode on the first substrate;
forming a first dielectric layer on the first electrode including the first substrate;
forming at least one second electrode on the second substrate;
forming a second dielectric layer on the second electrode;
forming at least one capillary per each discharge space in the second dielectric layer;
forming a field shaping layer on the second dielectric layer to confine a generated field into the capillary and eliminate a glow discharge,
wherein the discharge space faces into the capillary and each capillary corresponds to each discharge space.

33. The method according to claim 32, further comprising the step of forming a protective layer on the field shaping layer.

34. The method according to claim 32, further comprising the step of forming a Phosphor conversion layer on inner walls of the discharge space.

35. The method according to claim 32, further comprising the step of forming a third dielectric layer on the field shaping layer.

36. The method according to claim 32, wherein the step of forming at least one capillary is performed by a laser process.

37. The method according to claim 36, wherein the laser process is carried out under conditions of a laser fluence of at least 1.8 to 2.2 J/cm² and an ablation rate of about 0.111 μm/shot.

38. The plasma display panel according to claim 32, wherein a portion of the second electrode is exposed to each capillary.

39. The plasma display panel according to claim 32, wherein the second electrode and the capillary are separated by a distance up to a half thickness of the second dielectric layer.

40. A method of fabricating a capillary discharge plasma display panel having a pair of first and second substrates facing into each other with a discharge space there between for generating a capillary plasma discharge, the method comprising the steps of:
forming a first electrode on the first substrate;
forming a first dielectric layer on the first electrode including the first substrate;
forming at least a pair of second and third electrodes on the second substrate;
forming a second dielectric layer on the second and third electrodes and having at least one capillary therein; and
forming a field shaping layer on the second dielectric layer to confine a generated field into the capillary and eliminate a glow discharge,
wherein the discharge space directly faces into the capillary and at least one capillary corresponds to each discharge space.

41. The plasma display panel according to claim 40, wherein the capillary includes first and second capillaries respectively corresponding to the second and third electrodes.

42. The plasma display panel according to claim 40, wherein each adjacent first and second capillaries are formed to have an angle of about 45 degrees with respect to each discharge path.

43. The plasma display panel according to claim 40, further comprising the step of forming a protective layer on the field shaping layer.

44. The plasma display panel according to claim 40, further comprising at least a pair of barrier ribs to define the discharge space.

45. The plasma display panel according to claim 40, further comprising the step of forming a phosphor conversion layer on inner walls of the discharge space.

46. The method according to claim 40, wherein the step of forming at least one capillary is performed by a laser process.

47. The method according to claim 40, wherein the laser process is carried out under conditions of a laser fluence of at least 1.8 to 2.2 J/cm² and an ablation rate of about 0.111 μm/shot.

48. The plasma display panel according to claim 40, wherein a portion of the second electrode is exposed to each capillary.

49. The plasma display panel according to claim 40, wherein the second electrode and the capillary are separated by a distance up to a half thickness of the second dielectric layer.
